(19) United States
(12) Patent Application Publication
(10) Pub. No.: US 2022/0332659 A1
(43) Pub. Date: Oct. 20, 2022

(54) DUST BINDING AGENT FOR FERTILIZER

(71) Applicant: K+S AKTIENGESELLSCHAFT, Kassel (DE)

(72) Inventors: Sebastian KOPF, Bad Salzungen (DE); Christof DEHLER, Hofbieber (DE); Sören SEEBOLD, Bad Hersfeld (DE); Stefan DRESSEL, Kassel (DE); Guido BAUCKE, Schenklengsfeld OT Wippershain (DE)

(21) Appl. No.: 17/640,215

(22) PCT Filed: Sep. 7, 2020
(86) PCT No.: PCT/DE2020/000201

§ 371 Date: Mar. 3, 2022

(30) Foreign Application Priority Data
Sep. 10, 2019 (DE) 10 2019 006 367.8

(51) Int. Cl. C05G 3/20; C05G 5/12

(52) U.S. Cl. CPC C05G 3/20; C05G 5/12

(57) ABSTRACT

The present invention relates to a process for reducing the formation of dust from granules based on inorganic salts or urea, in particular from fertilizer granules of this type, in which process the granules are treated with at least one fatty acid triglyceride, which is liquid at 20° C., in combination with at least one amorphous silicic acid, wherein the weight ratio of triglyceride to silicic acid is 40:1 to 3:1, and relates to the use of this triglyceride/silicic acid combination as a dust binding agent for granules based on inorganic salts or for urea granules. The invention also relates to an oil composition containing 75 to 97.6 wt % of at least one fatty acid triglyceride, which is liquid at 20° C., having certain rheological properties, and 2.4 to 25 wt % of at least one amorphous silicic acid.

The present invention relates to a process for reducing the dust evolution of granules based on inorganic salts or urea, more particularly of fertilizer granules of this kind, wherein the granules are treated with at least one fatty acid triglyceride liquid at 20° C. in combination with at least one amorphous hydrophilic silica, the weight ratio of triglyceride to silica being 40:1 to 3:1. The invention further relates to an oil composition comprising 75 to 97.6 wt % of at least one fatty acid triglyceride liquid at 20° C. and having defined rheological properties, and 2.4 to 25 wt % of at least one amorphous hydrophilic silica. The invention additionally relates to the use of a combination of at least one fatty acid triglyceride liquid at 20° C. and at least one amorphous silica, the weight ratio of triglyceride to silica being 40:1 to 3:1, as an antidusting agent for granules based on inorganic salts or for urea granules.

Mineral fertilizers are used frequently in the form of granules, since in this form they have advantageous handling qualities. Hence granules, by comparison with the corresponding finely divided mineral fertilizers in powder form, have a greatly reduced tendency toward dusting, are more storage-stable and resistant to hygroscopy, and can be metered and delivered more easily and more uniformly by broadcasting. Granules applied to open fields are also less susceptible to wind drifting.

Since, however, such granules are frequently not particularly stable to mechanical loading, their transport and their filling into silos, transport containers and the like, for example, may be accompanied by not inconsiderable abrasion and hence the evolution of dust. It is obvious that, for reasons not least of workplace safety, the evolution of dust should be suppressed as far as possible. Dust evolution also implies material loss of product, reductions in quality, in some cases considerable, and adverse effects on the environment; moreover, the dust is frequently hygroscopic and may lead to caking of the granule particles. Accordingly, one of the markers of a good-quality product is a low level of dust evolution.

To reduce the evolution of dust by fertilizer granules, antidusting agents are typically employed, also referred to as dust preventives, dust reducers, dust control agents or dust binding agents. Typically these are liquid products which cause increased adhesion of the dust particles on the surface of the granule grains or result in agglomeration of the dust particles. Frequently they are mineral oils—see Fertilizer Manual, UN Industrial Development Organization, Int Fertilizer Development Center (Eds.) 3rd ed. Kluwer Academic Publishers, page 492 ff, and references cited therein.

DD 101657 describes the use of a solution of 5 to 40 wt % of bitumen in mineral oil for reducing the dusting of urea granules.

EP 255665 describes the use of a mixture of 2 to 10 wt % of polyethylene wax, 20 to 35 wt % of microcrystalline wax, and 70 to 80 wt % of mineral oil for reducing the hygroscopy and the dusting of nitrate-containing fertilizer granules.

WO 2016/168801 describes the use of stearates as antidusting agents, which are formulated with a mineral oil.

Antidusting agents based on mineral oils do exhibit a good dust-binding effect. In terms of environmental compatibility of fertilizers and other agricultural products, however, there is a desire to reduce the use of mineral oils in these products.

WO 02/090295 describes compositions which comprise a wax, an oil, such as a vegetable or animal oil, a natural resin or a resinous distillation residue of a vegetable or animal oil, and a surface-active substance, as a dusting-reducing additive for nitrogen fertilizers. These formulations, however, are complex and the necessary ingredients are not readily available.

DE 102011003268 describes antidusting agents for dry mixes of building material formulations. Antidusting agents used are hydrocarbons, natural oils, fatty acid derivatives or polysiloxanes applied to inorganic carriers. Preferred among these are fatty acids and fatty acid derivatives, more preferably hydrocarbons, and very preferably polysiloxanes. Silicas are among the suitable carriers stated. The carrier-bound dust reducing agents are generally in solid form and may at most be still pastelike. These carrier-bound formulations are said to enable the efficient incorporation of the dust reducing agents into dry building material formulations without any need for additional operations or equipment for the introduction of (liquid) dust reducing agents into the dry building material formulations.

This procedure, however, is not practical for less complex products or for formulations which are finished in principle, such as fertilizer formulations. In these cases it is generally desirable to be able to give the actually completed products or formulations an anti-dust evolution treatment in a single step.

Omitting the inorganic carrier material of the dust reducing formulation of DE 102011003268, however, does not lead to the desired objective. The present inventors, indeed, have determined that the single treatment of fertilizer formulations with vegetable oils has no dust-binding effect, or at least no satisfactory dust-binding effect.

EP 141410 describes a process for increasing the viscosity of oils wherein the oil is formulated with a combination of 0.1 to 10 wt % of a high-melting fatty acid triglyceride of saturated C₁₄-C₂₄ fatty acids and 0.2 to 10 wt % of a finely divided silica, more particularly a fumed silica. These formulations are proposed as cosmetic and pharmaceutical oils, lubricants, edible oils, or as release agents for bakery products.

CN 107793216 describes a fertilizer anticaking agent which comprises 10-20 wt % of hydrogenated tallowamine, 10-20 wt % of C₈-C₂₀ fatty acids or corresponding fats, 50-75 wt % of an oil component, and 5-10 wt % of modified nanosilica. The oils may, among others, be vegetable oils. The modified nanosilica is a hydrophobized silica modified with the silane coupling reagent KH550. No antidusting effect is described for this mixture. Nor is there any mention of the nature and form of the fertilizer.

It was an object of the present invention, therefore, to provide a dust-binding agent which effectively prevents or at least diminishes the dust evolution of inorganic granules, more particularly of (inorganic) fertilizer granules, and which is highly environmentally compatible, i.e., nontoxic and readily degradable. The agent ought also to be applicable to the granules in a simple way; more particularly it ought to be able to be applied by spraying or other methods for applying liquid components easily and without great cost and complexity of apparatus. The agent, furthermore, ought also to be applicable to granules fresh from production. Granules fresh from production are generally hot. If they have to be cooled before further processing this entails, among other disadvantages, a loss of time, which of course gives rise to costs. Pure vegetable oils are not suitable for such direct treatment of granules fresh from production, since they are presumably immediately absorbed by the granules.

Surprisingly it has been found that a combination of fatty acid triglycerides and amorphous silica in a defined quantitative ratio achieves the object of the invention.

A subject of the invention, therefore, is a method for reducing the dust evolution of granules based on inorganic salts or of urea granules, more particularly of (inorganic) fertilizer granules, which comprises treating the granules with a quantity of a combination comprising:
a) at least one fatty acid triglyceride liquid at 20° C. or at least one fatty acid triglyceride mixture liquid at 20° C., as component A;
b) at least one amorphous hydrophilic silica as component B,
   where said quantity reduces the dusting of the granules and where the mass ratio of component A to component B in said combination is in the range from 40:1 to 3:1, frequently in the range from 40:1 to 5:1, preferably in the range from 30:1 to 7:1, more particularly in the range from 27:1 to 8:1 and especially in the range from 25:1 to 9:1.

The invention also relates to the use of a combination comprising

a) at least one fatty acid triglyceride liquid at 20° C. or at least one fatty acid triglyceride mixture liquid at 20° C., as component A;
b) at least one amorphous silica as component B,
where the mass ratio of component A to component B in said combination is in the range from 40:1 to 3:1, frequently in the range from 40:1 to 5:1, preferably in the range from 30:1 to 7:1, more particularly in the range from 27:1 to 8:1 and especially in the range from 25:1 to 9:1, as an antidusting agent for granules based on inorganic salts or for urea granules, more particularly for (inorganic) fertilizer granules.

The invention further relates to an oil composition containing
a) 75 to 97.6 wt %, based on the total weight of the oil composition, of a fatty acid triglyceride liquid at 20° C. or of at least one fatty acid triglyceride mixture liquid at 20° C., as component A, where component A has a dynamic viscosity as determined according to DIN 53019-1:2008-09 in the range from 20 to 200 mPas at 20° C. and a shear rate of 1 s
b) 2.4 to 25 wt %, based on the total weight of the oil composition, of at least one amorphous hydrophilic silica as component B.

Another subject of the invention, lastly, are granules obtainable by the process of the invention.

### Definitions

The term “granules” refers to powder particle agglomerates which are obtainable by assembling powder particles into larger particle units, referred to as granule particles or granulates. The particle size (grain size) of the granule particles is generally in the range from 1 to 10 mm, preferably from 2 to 5 mm. The particle size here is determined by sieving according to DIN EN 1235 with a square mesh according to DIN ISO 3310-1.

Depending on their production, granules can have diverse shapes and morphologies and can be produced by a variety of processes. These processes employ a multiplicity of agglomeration methods and an even greater number of agglomeration devices. The fertilizer industry makes use, for example, of methods such as prilling, buildup agglomeration or press agglomeration.

In the case of prilling (spray crystallization), melts are broken down into small droplets in a prilling tower, for example, and are cooled in free fall by a cold countercurrent of fresh air. The solidified granules produced in this process are notable for very uniform particle size and particle morphology.

A feature of press agglomeration and buildup agglomeration is that disperse solid primary particles are merged with an increase in grain size. Both types of process are frequently performed in the presence of granulating assistants. These are liquids or solids whose adhesive forces result in cohesion between the primary particles. The use of such granulating assistants is required especially when the granulation of the primary particles without these assistants does not result in sufficiently stable granules. Known granulating assistants are, for example, water, gelatin, starch, lignosulfonates, lime, and molasses.

Press granulation is carried out generally with small fractions of liquids or with none admixed. The primary particles in the form of a powder are compacted using a force applied to the primary particles, resulting in an increase in the grain or particle diameter. In the case of press agglomeration, for example, the powder is compacted using roll presses. The resulting compact is referred to as flake. To obtain a defined grain size, compacting is followed by the comminution of the flakes using a mill, and optionally thereafter by classifying of the comminuted flakes, to give the desired size of granule in the form of the correctly sized target product. An apparatus for roll compacting commonly comprises the assemblies of a conveying system, which conveys the powder into the compacting zone between the rolls, a compacting unit, in which the powder is pressed to the flake between at least two contrarotating rolls with a defined force, and a milling unit, which comminutes the flake to the desired size, and also, optionally, a classifying unit.

The processes of buildup agglomeration also include, for example, roll granulation, in which the finely divided starting material, i.e., the primary particles, are agitated intensely with addition of an aqueous liquid, resulting in numerous collisions between the primary particles, which then congregate in the form of seeds by virtue of the capillary forces mediated by the liquid. These seeds can then congregate with one another or with further primary particles. The continual agitation results in an ongoing buildup of particle layers and in the compaction of the particles, ultimately producing moist granules (green granules), which are then dried and classified to form the completed granules.

As well as the target product, classifying also produces granules having particle sizes outside of the target fraction. Granules that are too large, also referred to as oversize, are generally comminuted following the classification and passed back to the respective granulating operation together with the granules that are too fine (undersize) from the classification. Granules of the target fraction in the respective agglomeration processes may be passed on for an aftertreatment in order to improve their properties.

The products obtained in the case of press agglomeration have a fairly angular form, at least by comparison with roll granules.

Fertilizers are substances which are used in agriculture in order to supplement the supply of nutrients for the crop plants being grown. For the purposes of the present invention, however, the term refers only to inorganic fertilizers (mineral fertilizers), i.e., inorganic salts suitable as fertilizers, and to urea. Urea, which may be regarded as a borderline compound between organic and inorganic chemistry, is considered for the purposes of the present invention to be an inorganic compound and is therefore included among the inorganic fertilizers.

The term “combination” of components A and B refers both to a physical mixture of the two components A and B and to any application form wherein the two components are employed separately but in a temporally close relationship. In the process of the invention and in the context of the use of the invention, therefore, the granules may be treated on the one hand with a physical mixture of components A and B, or on the other hand with component A and with component B separately, in which case the treatment with the individual components A and B may take place simultaneously or successively. In the case of successive treatment it is necessary to ensure that the two components are able to interact. This is ensured by means of sufficiently short time intervals between the treatments with the individual components. Further details of this follow below.

Component A is to be liquid at 20° C. “Liquid at 20° C.” in this context means that component A at 20° C. and a shear rate of 1 s⁻¹ has a dynamic viscosity as determined according to DIN 53019-1:2008-09 of not more than 200 mPas.

Fatty acid triglycerides are the triple esters of glycerol with fatty acids. The liquid mixtures of fatty acid triglycerides are more particularly vegetable oils, provided they have the requisite viscosity properties; also suitable, however, are synthetic mixtures.

Suitable vegetable oils are, for example, rapeseed oil, sunflower oil, corn oil, soybean oil, cottonseed oil, peanut oil, olive oil, safflower oil, hemp oil, palm olein, mixtures thereof, and mixtures of at least one of the aforesaid oils with palm oil or coconut oil.

The vegetable oils may be used both in native and in refined form.

Vegetable oils in refined form are those obtained from customary refining operations. In refining, the oils are purified chemically or physically by degumming, neutralization, bleaching, deodorizing, optionally delecithinizing, and optionally winterizing (removal of waxes and high-boiling triglycerides). Native vegetable oils in the sense of the present invention are those not subjected to refining.

Palm olein is the term for the liquid portion obtained in the separation of palm oil by fractionation (generally fractional crystallization). Oftentimes the starting material used for the fractionation is refined palm oil, or the palm olein obtained by the fractionation is subsequently refined, in order to remove color and odor. Palm olein meets the present requirement on component A, namely that it is liquid at 20° C.

In the trade and in the industry, the term “palm oil” is sometimes used imprecisely and also embraces palm oil fractions, such as palm olein. For the purposes of the present invention, however, this term is used only for unfractionated palm oil.

It may be useful to add customary antioxidants for stabilizing the vegetable oils.

The term “silica” is used in the context of the present invention for polymeric silicic acids and not, for instance, for orthosilicic acid or oligosilicic acids. It refers more precisely to polymeric silicic acids having a crosslinked structure, which ought actually to be referred to more correctly as silicic anhydride or silicon dioxide. Since, however, the industry continues to market such products under the silica designation, they are also referred to as silicas for the purposes of the present invention.

Amorphous silicas are noncrystalline silicas (that is, they do not have an ordered Si—O crystal lattice) and are also referred to—more correctly—as amorphous silicas. For the purposes of the present invention, the term does not embrace either glasses or kieselguhr (in the sense of radiolarian skeletons and diatomaceous earth). The amorphous silicas for the purposes of the present invention include silicas produced by wet processes, more particularly by precipitation, or by thermal processes, such as precipitated silica (precipitated silicon dioxide) and fumed silica (pyrogenic silicon dioxide). The silicas may be used both in hydrophilic and in hydrophobized form.

Hydrophilic silicas are untreated silicas; more precisely, unhydrophobized silicas. In hydrophilic silicas there are free silanol groups (Si—OH). In hydrophobized silicas, conversely, at least some of the silanol groups have been converted into hydrophobic groups. Hydrophobizing may be achieved, for example, by reacting hydrophilic silica with silanes, siloxanes, polysiloxanes or waxes, as for example with dimethyldichlorosilane (DDS), hexamethyldisilazane (HMDS), octamethylcyclotetrasiloxane (OMS; OMCTS; D4) or polydimethylsiloxane (PDMS). Hydrophobized silicas typically have a carbon content as determined according to DIN EN ISO 3262-19:2000-10 of at least 0.5 wt %, more particularly of at least 1 wt %, based on the total weight of the silica.

However, this does not necessarily mean conversely that hydrophilic silicas contain no carbon, since there may be contamination with carbon-containing components from the silica source or from its processing operation. Hydrophilic silicas in the sense of the present invention, however, do have a carbon content as determined according to DIN EN ISO 3262-19:2000-10 of less than 0.5 wt %, preferably of less than 0.2 wt %, more particularly of less than 0.1 wt %, especially of about 0 wt %, based on the total weight of the silica. The term “about” 0 wt % here is intended to take account of any measurement inaccuracies.

Carbon content in this context refers to the content of organic carbon as introduced, for example, via the hydrophobizing. Any carbon introduced by adsorbed CO₂ or other inorganic carbon sources, such as carbonates, is not covered by the specified carbon contents.

“Mass ratio”, “weight ratio”, and “quantitative ratio” are used synonymously for the purposes of the present invention.

Linear C₆-C₂₂ alkyl stands, for example, for n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-henicosyl or n-docosyl. Linear C₁₁-C₁₇ alkyl stands, for example, for n-undecyl, n-dodecyl, n-tridecyl, n-tetradecyl, n-pentadecyl, n-hexadecyl or n-heptadecyl.

### PREFERRED EMBODIMENTS

Component A is preferably selected from vegetable oils, which are of course required to meet the above proviso (liquid at 20° C.). Suitable vegetable oils and vegetable oil mixtures have been stated above.

Factors influencing the viscosity of the vegetable oils, in addition to the chain length of the hydrocarbon radical of the fatty acids, include in particular the factor of whether the hydrocarbon radical is saturated or unsaturated and how many C—C-double bonds the radical contains. The higher the fraction of unsaturated fatty acids in the oils and the greater the number of double bonds in the hydrocarbon radicals, the lower the viscosity.

Particular preference among the vegetable oils, accordingly, is given to those having a Wijs iodine value in the range from 20 to 160, preferably from 50 to 160, more particularly from 100 to 150, determined according to DIN 53241-1:1995-05. In vegetable oil mixtures, preferably at least one of the vegetable oils contained therein has the abovementioned iodine value. More particularly, however, all of the vegetable oils contained in the mixture have the abovementioned iodine value.

Component A at 20° C. and a shear rate of 1 s⁻¹ preferably has a dynamic viscosity as determined according to DIN 53019-1:2008-09, in the range from 20 to 200 mPas, more preferably from 20 to 150 mPas, and more particularly from 30 to 100 mPas.

Component A is preferably selected from rapeseed oil, sunflower oil, corn oil, soybean oil, cottonseed oil, peanut oil, olive oil, safflower oil, hemp oil, palm olein, mixtures of the aforesaid oils, and mixtures of at least one of the aforesaid vegetable oils with palm oil and/or coconut oil. Component A is selected more particularly from rapeseed oil, sunflower oil, soybean oil, palm olein, mixtures of at least two of the aforesaid oils, and mixtures of at least one of the aforesaid vegetable oils with palm oil and/or coconut oil.

If mixtures of the aforesaid vegetable oils with palm oil and/or coconut oil are used, the weight ratios are of course selected such that the mixture is liquid at 20° C. The mixture will generally contain at most 80 wt %, preferably at most 70 wt %, more particularly at most 60 wt %, and especially at most 55 wt % of palm oil and/or coconut oil, based on the weight of the mixture of aforesaid vegetable oil and palm oil/coconut oil.

The vegetable oils may be used both in native form and in refined form.

Palm olein and palm oil are frequently used in refined form, as their natural color and their odor may cause disruption.

Component B is an amorphous silica. As explained above, amorphous silicas are noncrystalline, meaning that they do not have an ordered Si—O crystal lattice. Suitable amorphous silicas have a relatively high specific surface area. Suitable amorphous silicas are obtainable by wet processes, more particularly by precipitation, or by thermal processes, such as flame hydrolysis.

The amorphous silicas are preferably finely divided and have a specific surface area as determined by nitrogen adsorption according to the BET method to DIN ISO 9277:2014-01 at 77.3 K of preferably at least 50 m²/g, more particularly from 80 to 600 m²/g, very preferably from 100 to 600 m²/g, especially from 150 to 400 m²/g, and very specially from 150 to 300 m²/g.

The amorphous silicas are preferably selected from fumed silica, precipitated silica, and mixtures thereof.

Fumed silica is produced by flame hydrolysis of silicon tetrachloride. This silicon tetrachloride is burned in the gas phase with hydrogen and air using a burner in a cooled combustion chamber. Initially formed in the flame are dropletlike silicon dioxide particles, which attach to one another in chains and through branching form three-dimensional secondary particles; these particles accumulate in turn to form tertiary particles.

Precipitated silica comes about through precipitation with sulfuric acid from waterglass solution.

Precipitated silicas and fumed silicas generally differ in that the former have a somewhat broader particle size distribution and a somewhat higher tamped density, determined according to DIN EN ISO 787-11:1995-10, than the latter.

The silicas may be used both in hydrophilic form and in hydrophobized form. In the process of the invention and in the oil composition of the invention, however, the silicas are used in hydrophilic form.

Hydrophilic silicas, however, are also more strongly preferred for the use in accordance with the invention.

The amorphous silicas are available commercially. Examples of suitable precipitated silicas are the Sipernat®, Ultrasil® and Sident® products from Evonik and the LoVel® and HiSil® products from DuPont. Examples of suitable fumed silicas are the Aerosil®, Aerodisp®, Aeroxid® and Aeroperl® products from Evonik and the HDK® products from Wacker Chemie AG. Suitable silicas additionally are the Syloid® products from Grace, the Sylysia® products from Fuji, the Köstrosorb® products from Chemiewerke Bad Köstritz, the Gasil® and NeoSyl® products from Ineos, and the Cab-O-Sil® products from Cabot.

Examples of hydrophilic fumed silicas notably include the following Aerosil® products (the respective BET surface area is given in brackets; the pH ranges between 3.5 and 5.5): Aerosil® 90 (90±15 m²/g), Aerosil® 130 (130±25 m²/g), Aerosil® 150 (150±15 m²/g), Aerosil® 200 (200±25 m²/g), Aerosil® 255 (255±25 m²/g), Aerosil® 300 (300±30 m²/g), Aerosil® 380 (380±30 m²/g), Aerosil® OX 50 (50±15 m²/g), Aerosil® TT 600 (200±50 m²/g), Aerosil® 200 F (200±25 m²/g), Aerosil® 380 F (380±30 m²/g), Aerosil® 200 Pharma (200±25 m²/g), Aerosil® 300 Pharma (300±25 m²/g).

Examples of hydrophilic precipitated silicas notably include the following Sipernat® products (the respective BET surface area—where known—is given in brackets): Sipernat® FPS-101, Sipernat® 11 PC, Sipernat® 120 (about 125 m²/g), Sipernat® 160 (about 165 m²/g), Sipernat® 186 (about 195 m²/g), Sipernat® 218 (about 160 m²/g), Sipernat® 22 (about 190 m²/g), Sipernat® 22 LS (about 180 m²/g), Sipernat® 22 PC, Sipernat® 22 S (about 190 m²/g), Sipernat® 22 S ex Thailand, Sipernat® 2200 (about 190 m²/g), Sipernat® 2200 PC, Sipernat® 236 (about 180 m²/g), Sipernat® 238 (about 195 m²/g), Sipernat® 25 (about 190 m²/g), Sipernat® 266 (about 160 m²/g), Sipernat® 268 (about 180 m²/g), Sipernat® 288 (about 200 m²/g), Sipernat® 298 (about 210 m²/g), Sipernat® 303 (about 565 m²/g), Sipernat® 310 (about 700 m²/g), Sipernat® 320 (about 180 m²/g), Sipernat® 320 DS (about 175 m²/g), Sipernat® 325 AP (about 130 m²/g), Sipernat® 325 C (about 130 m²/g), Sipernat® 325 E, Sipernat® 33, Sipernat® 340 (about 175 m²/g), Sipernat® 35 (about 170 m²/g), Sipernat® 350 (about 55 m²/g), Sipernat® 383 DS (about 175 m²/g), Sipernat® 50 (about 500 m²/g), Sipernat® 50 S (about 500 m²/g), Sipernat® 500 LS (about 500 m²/g), Sipernat® 609, Sipernat® 612, Sipernat® 622, Sipernat® BG-2, Sipernat® FPS-5.

Examples of hydrophobic silicas notably include the following Sipernat® products (the respective BET surface area—where known—is given in brackets): Sipernat® D 10, Sipernat® D 13, Sipernat® D 17 (about 100 m²/g).

Specific examples of suitable silicas are notably Aerosil® 200, Aerosil® 200 F, Sipernat® 22, Sipernat® 22 LS, Sipernat® 22 PC, Sipernat® 22 S, Sipernat® 22 S ex Thailand and Sipernat® D 17, and more particularly Aerosil® 200 F, Sipernat® 22 S and Sipernat® D 17. Preference among these is given to Aerosil® 200, Aerosil® 200 F, Sipernat® 22, Sipernat® 22 LS, Sipernat® 22 PC, Sipernat® 22 S and Sipernat® 22 S ex Thailand, and more particularly Aerosil® 200 F and Sipernat® 22 S.

Component A and component B are used preferably in a mass ratio of A to B in the range from 40:1 to 5:1, more preferably from 30:1 to 7:1, more particularly in the range from 27:1 to 8:1, and especially in the range from 25:1 to 9:1.

The combination comprising components A and B consists preferably to an extent of at least 80 wt %, more particularly at least 85 wt %, based on the total weight of the combination, of components A and B. The remaining constituents, where present, are generally anticaking agents and possibly technical impurities. If no anticaking agent is used, the combination comprising components A and B consists preferably to an extent of at least 90 wt %, more preferably at least 95 wt %, more particularly at least 98 wt %, especially at least 99 wt %, based on the total weight of the combination, of components A and B.

Anticaking agents are substances which prevent or reduce the clumping, concretion or sticking-together of substances in powder or granular form. Suitable anticaking agents are those customarily used in solid fertilizer formulations. These are, for example, fatty amines, alkoxylated fatty amines, fatty amine acetates, mixtures of fatty amines with fatty alcohols, fatty acids, or mixtures of the aforesaid compounds. The fatty amines (also in the form of their derivatives) in this context are compounds R—NH₂, in which R is a long-chain alkyl radical, generally a linear alkyl radical, usually linear C₆-C₂₂ alkyl. Alkoxylated fatty amines are obtainable by reaction of fatty amines with ethyl oxide (EO) and/or propylene oxide (P0), e.g., with 2 to 20 mol, especially 4 to 15 mol, of E0 and/or PO per mole of amine. The fatty alcohols in this context are compounds R—OH, in which R is a long-chain alkyl radical, generally a linear alkyl radical, usually linear C₆-C₂₂ alkyl. The fatty acids in this context are compounds R—C(═O)OH, in which R is a long-chain alkyl radical, generally a linear alkyl radical, usually linear C₁₁-C₁₇ alkyl.

Without wishing to be bound by the theory, it is thought that the amorphous silica modifies the rheological behavior of the triglycerides, thickens them, and so prevents them being immediately absorbed by the granules following application to said granules and therefore being able to make only a limited contribution to suppressing the evolution of dust. This effect is particularly pronounced for finely divided silicas. As a result of the prevention or reduction of absorption, the triglyceride remains on the surface and is able to develop its dust-suppressing effect. This effect, surprisingly, is retained even when the granules are still hot on treatment and have a temperature, for example, of up to 60° C. or even up to 70° C. or up to 80° C.

This effect, surprisingly, is observed not only for the treatment of the granules with a mixture of components A and B but also when components A and B are applied separately. The components in this case may be applied simultaneously or successively. In the case of successive treatment, it is of course necessary for this treatment to take place within a sufficiently short time so that the individual components can still interact.

In the process of the invention, therefore, components A and B for treating the granules may be used in a mixture or separately, simultaneously or successively.

In one embodiment the granules are treated with a mixture (a composition) containing components A and B.

In an alternative embodiment components A and B are used separately to treat the granules, with the granules being treated concurrently with component A and component B.

In a further alternative embodiment, components A and B are used separately and successively for treating the granules, meaning that the granules are treated not concurrently but instead successively with components A and B. The time interval between the treatment with component A and the treatment with component B in this case is preferably at most 2 minutes, more preferably at most 1 minute, and more particularly at most 30 seconds. The sequence of the successive treatment is in principle arbitrary; for practical reasons, however, it is preferred to treat the granules first with component A and subsequently with component B.

If components A and B are used in a mixture, it is preferred to use them in the form of an oil composition which contains
a) 75 to 97.6 wt %, preferably 83.3 to 97.6 wt %, more preferably 87.5 to 96.8 wt %, more particularly 88.9 to 96.4 wt %, especially 88.9 to 96.2 wt %, based on the total weight of the oil composition, of component A; and
b) 2.4 to 25 wt %, preferably 2.4 to 16.7 wt %, more preferably 3.2 to 12.5 wt %, more particularly 3.6 to 11.1 wt %, especially 3.8 to 11.1 wt %, based on the total weight of the oil composition, of component B.

The granules are treated preferably by spray application, dropwise introduction or running of the mixture/oil composition into the granules. Contrary to the expectation that a mixture of components A and B, because of the thickening effect of component B on component A, would hinder or even render impossible a spraying process in particular, because of the greatly increased viscosity, spraying processes can in fact be employed very effectively, as the mixture is shear-thinning. This means that at relatively high shear rates, of the kind typically occurring in spraying processes, the viscosity of the mixture drops to an extent such that the mixture becomes sprayable.

Preferably in this case the oil composition at 20° C. and a shear rate of 1 s⁻¹ has a dynamic viscosity of at least 500 mPas and at 20° C. and a shear rate of 300 s⁻¹ has a dynamic viscosity which is at least 200 mPas below the dynamic viscosity of the oil composition at 20° C. and a shear rate of 1 s⁻¹) the viscosity values being determined according to DIN 53019-1:2008-09.

It is, however, simpler to use components A and B separately, simultaneously or successively, since with this procedure the viscosity on spraying is not an issue.

In the case of successive treatment, component A is preferably first sprayed onto the granules or is introduced dropwise or run into them, and then mixes with component B; this may be accomplished, for example, with the aid of customary stirrers and mixers. Examples of suitable mixers are gravity mixers with and without internals, such as drum mixers and ring mixers, paddle mixers such as trough mixers, ploughshare mixers and double-shaft mixers, and also screw mixers, mixing boxes and other known mixing elements.

The simultaneous but separate treatment with components A and B may be accomplished, for example, by mixing the granules with the solid (pulverulent) component B and at the same time spraying them with the liquid component A and/or introducing this component A dropwise or running it into the mixer during the mixing procedure.

Components A and B are used preferably in a total amount of 1 to 10 kg per metric ton of granules, more particularly of 2 to 7 kg per metric ton of granules.

Where the combination includes anticaking agents, they can be used in a mixture with one or with both components A and B or separately from the latter. For purely practical reasons, they are used in particular in a mixture with component A.

Where anticaking agents are used, they are employed preferably in a total amount of 100 to 500 g per metric ton of granules, more particularly of 200 to 350 g per metric ton of granules.

The granules for treatment are granules based on inorganic salts or based on urea. More particularly they are fertilizer granules, more specifically inorganic fertilizer granules, which contain inorganic salts and/or urea, where the inorganic salts are those suitable as fertilizers. The process of the invention is suitable for any desired shapes and types of granule and is not limited to particular kinds.

The inorganic salts suitable as fertilizers generally contain at least one of the following elements (macronutrients): potassium, nitrogen, phosphorus, magnesium, sulfur, and calcium. Potassium, magnesium, and calcium generally take the form of potassium, magnesium or calcium chlorides or sulfates; as a secondary component, however, they may also occur in the form of carbonates or oxides. They may additionally occur in the form of nitrates or phosphates. Nitrogen is present generally in the form of ammonium or of nitrate. Phosphorus is generally present in the form of phosphate. Sulfur is generally present in the form of sulfate or in elemental form.

Preferably, therefore, the fertilizer granules are granules based on sulfate, chloride, phosphate or nitrate salts of potassium, magnesium, calcium or ammonium, based on mixtures thereof, based on mixed salts thereof, based on mixtures of mixed salts thereof with at least one of the above-stated salts, based on urea, more particularly pressed urea, or based on a mixture of at least one of the above-stated salts or mixed salts with urea. “Based on” is intended to mean that the granules may also contain other components, examples being the aforementioned oxides and carbonates and/or the below-stated micronutrients and optionally further components used in the production of granules, such as binders, dyes, etc. Mixed salts are salts having two or more different cations or different anions, examples being double salts (salts with two different cations or two different anions), triple salts (salts with three different cations or three different anions), etc.

Mixed salts, as already mentioned, are salts having two or more different cations or different anions. They are formed when different salts are dissolved in a solution and crystallize out together in a regular crystal structure. In aqueous solution they dissociate into their individual ions. Double salts are salts having two different cations or two different anions; triple salts are salts having three different cations or three different anions. In the present case the mixed salts are more particularly those having different cations.

Examples of suitable salts are potassium sulfate, potassium chloride, magnesium sulfate, magnesium chloride, magnesium oxide, calcium sulfate, calcium chloride, calcium carbonate, calcium oxide, calcium nitrate, potassium nitrate, ammonium nitrate, ammonium sulfate, mono- and diammonium phosphate, calcium phosphate, and mixtures thereof. Also suitable are mixed salts (especially double or triple salts) composed of the aforementioned compounds, such as polyhalite (K₂Ca₂Mg[SO₄]₄.2H₂O), carnallite (KMgCl₃.6H₂O), schoenite (syn. picromerite; K₂Mg[SO₄]₂.6H₂O), leonite (K₂Mg(SO₄)₂.4H₂O), langbeinite (K₂Mg₂[SO₄]₃), syngenite (K₂Ca[SO₄]₂.H₂O), and the like.

As well as the aforementioned macronutrients, the fertilizers may also contain micronutrients, such as boron, copper, iron, manganese, molybdenum, nickel, and zinc. These are used in the granules typically in the form of their salts or complex compounds. Manganese, copper, and zinc are used usually in the form of their sulfates. Copper and iron are also used in the form of chelates, with EDTA, for example, or else as oxides. Boron is used customarily as calcium sodium borate, e.g., in the form of ulexite, sodium borate, potassium borate or boric acid. Molybdenum is frequently used as sodium or ammonium molybdate or a mixture thereof. Typically the fraction of micronutrients other than boron, calculated in their elemental form, will not exceed 1 wt %, based on the total mass of the granules. The boron content, calculated as B₂O₃ will generally not exceed 3 wt % and typically, if included, is in the range from 0.01 to 3 wt %, more particularly 0.01 to 2 wt %, based on the total mass of the constituents of the granules.

Suitable salts and salt mixtures are available commercially and are known for example under the following product names: SOP (main constituent: potassium sulfate; plus small fractions of calcium sulfate and magnesium sulfate and also potassium chloride and sodium chloride); MOP (main constituent: potassium chloride; plus small fractions of sodium chloride and magnesium chloride and also magnesium sulfate, potassium sulfate and calcium sulfate), Korn-Kali from K+S (main constituent: potassium chloride; plus magnesium sulfate and sodium chloride; additionally small fractions of magnesium chloride and also potassium sulfate and calcium sulfate), Patentkali from K+S (main constituent: potassium sulfate; plus magnesium sulfate; also leonite and langbeinite; additionally small fractions of calcium sulfate and other sulfates and also potassium chloride and sodium chloride), kieserite (main constituent: magnesium sulfate monohydrate or 5/4-hydrate), NPK fertilizers, MAP (monoammonium phosphate); DAP (diammonium phosphate), CAS (lime ammonium saltpeter; mixture of ammonium nitrate and calcium carbonate); TSP (triple superphosphate). Granules not available commercially are of course also suitable.

Urea-based granules, more particularly pressed urea granules, are likewise known.

Also suitable are granules containing both inorganic salts and urea. A number of NPK granules contain such combinations.

The granules may have any desired shapes and morphologies and may be obtainable by various processes. Press granules, roll granules and spray granules may be mentioned, merely as catchwords. Details of their production have already been described above.

The granules based on inorganic salts may alternatively be produced by conventional methods for producing granules from finely divided inorganic salts, as are described, for example, in Wolfgang Pietsch, Agglomeration Processes, Wiley—VCH, 1^{st} edition, 2002, in G. Heinze, Handbuch der Agglomerationstechnik, Wiley—VCH, 2000 and in Perry's Chemical Engineers' Handbook, 7^{th} edition, McGraw-Hill, 1997, pp. 20-56 to 20-89. Both buildup and breakdown agglomeration processes are suitable.

The particle size (grain size) of the granule particles is generally in the range from 1 to 10 mm. The fraction of granule particles having a grain size below 1 mm is commonly low and amounts for example to less than 10 wt %, more particularly less than 5 wt %. Preferably at least 60 wt %, more particularly at least 80 wt %, and especially at least 90 wt % of the granule particles have a grain size in the range from 2 to 5 mm. It is advantageous for less than 10 wt % of the granule particles to have a grain size below 2 mm. The grain size here is determined by sieving according to DIN EN 1235 with a square mesh according to DIN ISO 3310-1. The distribution of the grain sizes in the granule particles may be determined in a conventional way by sieve analysis.

The process of the invention results in a significantly reduced evolution of dust in the handling of granules. The reduced dust evolution can be perceived on a qualitative basis simply visually, when samples of the granules obtained in accordance with the invention and samples of untreated granules are vigorously shaken, for example, and the evolution of dust is compared. The effect can be quantified using, for example, the test method described in the examples.

Components A and B can be applied in a simple way without complex process steps to the granules. There is no need for the components to be heated, especially not component A or the mixture of component A and B; component A, and mixtures of components A and B, can be used at room temperature (20-25° C.) or even at lower temperatures for the purpose of treating the granules, and this significantly reduces the outlay for apparatus and energy.

A further advantage of the process of the invention relative to the use of mineral oils as antidusting agents or of pure vegetable oils or vegetable oil mixtures is that components A and B can be applied to hot granules, as they come freshly from the production process, for example. This does not work with vegetable oils or with unthickened or slightly thickened mineral oils, since they are immediately absorbed by the granules. While high-melting mineral oils can be applied to hot granules, these mineral oils do have to be heated for the purpose, and that entails some outlay in apparatus and energy. This is accomplished nevertheless with the combination of components A and B according to the invention.

The invention also relates to the use of a combination comprising
a) at least one fatty acid triglyceride liquid at 20° C. or at least one fatty acid triglyceride mixture liquid at 20° C., as component A;
b) at least one amorphous silica as component B,
   where the mass ratio of component A to component B in said combination is in the range from 40:1 to 3:1, as an antidusting agent for granules based on inorganic salts or for urea granules, more particularly for fertilizer granules.

The observations made for the process of the invention, regarding suitable and preferred embodiments, are valid here correspondingly. It is noted only that in this context the amorphous silica may be used both in hydrophilic and in hydrophobized form, the hydrophilic form being preferred.

The invention also relates to an oil composition containing
a) 75 to 97.6 wt %, based on the total weight of the oil composition, of a fatty acid triglyceride liquid at 20° C. or of at least one fatty acid triglyceride mixture liquid at 20° C., as component A, where component A has a dynamic viscosity as determined according to DIN 53019-1:2008-09 in the range from 20 to 200 mPas at 20° C. and a shear rate of 1 s⁻¹;
b) 2.4 to 25 wt %, based on the total weight of the oil composition, of at least one amorphous hydrophilic silica as component B.

The observations made in connection with the process of the invention, regarding preferred embodiments of components A and B, are valid here correspondingly.

Accordingly, component A is preferably selected from vegetable oils which are of course required to meet the above proviso (liquid at 20° C. and dynamic viscosity as determined according to DIN 53019-1:2008-09, in the range from 20 to 200 mPas at 20° C. and a shear rate of 1 s⁻¹).

Among the vegetable oils and vegetable oil mixtures, preference is given to those having a Wijs iodine value in the range from 20 to 160, preferably from 50 to 160, more particularly from 100 to 150, determined according to DIN 53241-1:1995-05.

Component A at 20° C. and a shear rate of 1 s⁻¹ preferably has a dynamic viscosity as determined according to DIN 53019-1:2008-09, in the range from 20 to 150 mPas and more particularly from 30 to 100 mPas.

Component A is preferably selected from rapeseed oil, sunflower oil, corn oil, soybean oil, cottonseed oil, peanut oil, olive oil, safflower oil, hemp oil, palm olein, mixtures of the aforesaid oils, and mixtures of at least one of the aforesaid vegetable oils with palm oil and/or coconut oil. Component A is selected more particularly from rapeseed oil, sunflower oil, soybean oil, palm olein, mixtures of at least two of the aforesaid oils, and mixtures of at least one of the aforesaid vegetable oils with palm oil and/or coconut oil.

Component B is an amorphous silica. Suitable amorphous silicas have a relatively high specific surface area. They are obtainable by wet processes, more particularly by precipitation, or by thermal processes, such as flame hydrolysis. The silicas are used in hydrophilic form.

The amorphous silicas are preferably finely divided and have a specific surface area as determined by nitrogen adsorption according to the BET method to DIN ISO 9277:2014-01 at 77.3 K of preferably at least 50 m²/g, very particularly from 80 to 600 m²/g, more particularly from 100 to 600 m²/g, especially from 150 to 400 m²/g, and very specially from 150 to 300 m²/g.

The amorphous silicas are preferably selected from fumed silica, precipitated silica, and mixtures thereof.

The amorphous silicas are available commercially. Suitable commercial products have been stated above. In this context as well, specific examples of particularly suitable silicas that may be highlighted include Aerosil® 200, Aerosil® 200 F, Sipernat® 22, Sipernat® 22 LS, Sipernat® 22 PC, Sipernat® 22 S and Sipernat® 22 S ex Thailand, and more particularly Aerosil® 200 F and Sipernat® 22 S.

In a particularly preferred group 1 of embodiments of the oil compositions claimed in the invention, component B is selected from precipitated silicas and mixtures thereof with fumed silicas, with the proviso that component B in the preferred group 1 comprises at least 50 wt %, more particularly at least 80 wt %, based on the total mass of component B, of at least one precipitated silica.

In another particularly preferred group 2 of embodiments of the oil compositions claimed in the invention, component B is selected from fumed silicas and mixtures thereof with precipitated silicas, with the proviso that component B in the preferred group 2 comprises more than 50 wt %, more particularly at least 80 wt %, based on the total mass of component B, of at least one fumed silica.

In another particularly preferred group 2a of embodiments of the oil compositions claimed in the invention, component B in the oil composition is contained in an amount of at least 6.5 wt %, based on the total weight of the oil composition, when component B is selected from fumed silicas.

The oil composition contains preferably 83.3 to 97.6 wt %, based on the total weight of the oil composition, of component A, and 2.4 to 16.7 wt %, based on the total weight of the oil composition, of component B. More preferably the oil composition contains 87.5 to 96.8 wt %, based on the total weight of the oil composition, of component A, and 3.2 to 12.5 wt %, based on the total weight of the oil composition, of component B. More particularly the oil composition contains 88.9 to 96.4 wt %, based on the total weight of the oil composition, of component A, and 3.6 to 11.1 wt %, based on the total weight of the oil composition, of component B. Especially the oil composition contains 88.9 to 96.2 wt %, based on the total weight of the oil composition, of component A, and 3.8 to 11.1 wt %, based on the total weight of the oil composition, of component B.

The oil composition contains component A and component B in a mass ratio of A to B in the range from 40:1 to 3:1, more preferably from 40:1 to 5:1, very preferably from 30:1 to 7:1, more particularly from 27:1 to 8:1, and especially from 25:1 to 9:1.

In groups 1, 2 and 2a of embodiments, the components A and B of the invention make up preferably in total at least 80 wt %, more particularly at least 85 wt %, of the total oil composition. The other constituents, where present, are generally anticaking agents and possibly technical impurities. If no anticaking agent is used, the components A and B of the invention make up preferably at least 90 wt %, more preferably at least 95 wt %, very preferably at least 99 wt %, more particularly at least 99.5 wt % and especially at least 99.9 wt %, of the total oil composition.

Regarding suitable anticaking agents, refer to the observations above.

The oil composition is preferably shear-thinning. This means that at high shear rates, of the kind typically occurring in the case of spraying processes, for example, the viscosity of the mixture drops sharply enough for the mixture to become sprayable. In particular the viscosity of an oil composition of the invention at 20° C. and a shear rate of 1 s⁻¹ is higher by a factor of at least 1.2, more particularly by a factor of at least 1.5, than the viscosity of this oil composition at 20° C. and a shear rate of 300 s⁻¹. The viscosity of the oil composition of the invention at 20° C. and a shear rate of 300 s⁻¹ will preferably not exceed a figure of 700 mPas and more particularly a figure of 500 mPas, and is situated preferably in the range from 100 to 700 mPas and more particularly in the range from 110 to 500 mPas.

The viscosities are the values determined in accordance with DIN 53019-1:2008-09 at 20° C. using a rotational viscometer having a plate/plate measuring system with a plate-to-plate spacing of 1 mm (plate diameter 6 mm) at the specified shear rate.

The invention, lastly, relates to granules obtainable by the process of the invention.

The observations made in connection with the process of the invention and the oil composition of the invention regarding preferred embodiments of components A and B and regarding the granules are valid here correspondingly.

The granules contain components A and B in a total amount of preferably 1 to 10 kg per metric ton of (untreated) granules, more particularly from 2 to 7 kg per metric ton of (untreated) granules. Components A and B here are present in the above-stated general or preferred mass ratios.

“Untreated granules” here refer to the granules as present prior to the treatment with components A and B.

The granules of the invention per metric ton contain, accordingly, preferably 750 g to 9.76 kg of component A and 24 g to 2.5 kg of component B, with components A and B being present in the above-specified general or preferred mass ratios (40:1 to 3:1, preferably 40:1 to 5:1, more preferably 30:1 to 7:1, more particularly 27:1 to 8:1 and especially 25:1 to 9:1). More particularly the granules per metric ton contain 1.50 kg to 6.83 kg of component A and 49 g to 1.75 kg of component B, with components A and B being present in the above-specified general or preferred mass ratios (40:1 to 3:1, preferably 40:1 to 5:1, more preferably 30:1 to 7:1, more particularly 27:1 to 8:1 and especially 25:1 to 9:1).

The granules of the invention exhibit significantly reduced evolution of dust by comparison with granules not treated as per the invention, and at the same time suffer no adverse modification to their flow behavior as a result; that is, they do not stick and cake to any greater extent than granules not subjected to the process of the invention. Moreover, the granules do not introduce any difficult-to-degrade or otherwise ecologically relevant components into the environment.

The invention is illustrated by the examples which follow.

### EXAMPLES

Oils used were as follows:

### Rapeseed oil

### Sunflower oil

### Soybean oil

RBD palm oil from Olenex (RBD=refined bleached deodorized)
RBD palm olein 64 SG from Olenex (refined palm olein; RBD=refined bleached deodorized)
Silica products used were as follows:
Sipernat® 22 S from Evonik
Sipernat® 50 from Evonik
Sipernat® D 17 from Evonik
Aerosil® 200 F from Evonik

Additionally tested for comparison were quartz sand as a different source of silicon, and also precipitated calcium carbonate.

As fertilizer granules the following products were used:

### SOP:

Press granules

### Granulometry 2-4 mm (80-90%)

D₅₀ typically 2.8 mm
Chemical composition:

| | |
|---|---|
| K₂SO₄ | typically 93.5% |
| Other sulfates (MgSO₄, CaSO₄) | typically 3% |
| Chlorides (KCl, NaCl) | typically 1.5% |
| Others (primarily water of crystallization) | typically 2% |

### MOP:

Press granules

### Granulometry 2-4 mm (85-95%)

D₅₀ typically 2.8 mm
Chemical composition:

| | |
|---|---|
| KCI | typically 95.4% |
| Secondary constituents (NaCl, MgCl₂, MgSO₄, K₂SO₄, | typically 4.4% |
| CaSO₄) | |
| Adhering moisture | typically 0.2% |

### Korn-Kali (Granular Potash):

Press granules
Granulometry 2-5 mm (about 94%)
D₅₀ typically 3.4 mm
Chemical composition:

| | |
|---|---|
| KCl | typically 63.5% |
| NaCl | typically 9.5% |
| MgSO₄ | typically 17.0% |
| MgCl₂, K₂SO₄, CaSO₄ | typically 5.5% |
| Others (primarily water of crystallization) | typically 4.5% |

### Patentkali (Patent Potash):

Roll granules
Granulometry 2-5 mm (about 92%)
D₅₀ typically 3.1 mm
Chemical composition:

| | |
|---|---|
| K₂SO₄ | typically 50.5% |
| MgSO₄ | typically 30.5% |
| Other sulfates (CaSO₄ etc.) | typically 1.5% |
| Chlorides (KCl, NaCl) | typically 5.5% |
| Others (primarily water of crystallization) | typically 12% |

### NPK:

Granulometry 2-4 mm (about 95%)
D₅₀ typically 3.2 mm
Chemical composition:

| | |
|---|---|
| K₂O | typically 15% |
| N (ammonium) | typically 15% |
| P₂O₅ (phosphate) | typically 13% |
| S (sulfate) | typically 11% |
| Chlorides | typically 12% |

### 1) Rheological Study of the Starting Materials

The dynamic viscosity of the vegetable oils and of the mixtures with the amorphous silicas was determined according to DIN 53019-1:2008-09 at 20° C. (unless otherwise noted). For this purpose an MCR 502 from Anton Paar was used with a plate-to-plate distance of 1 mm (plate diameter 6 mm).

The dynamic viscosity of the oils is shown in table 1.

TABLE 1

Dynamic viscosity [mPas]

| | Shear rate 1 s⁻¹ | Shear rate 300 s⁻¹ |
|---|---|---|
| RBD palm oil FP | n.d. | 257 |
| RBD palm olein | 87 | 88 |
| Rapeseed oil | 72 | 73 |
| Sunflower oil | 69 | 66 |
| Soybean oil | 66 | 65 |

Various mixtures of rapeseed oil and amorphous silicas or quartz sand as other source of silicon and/or precipitated calcium carbonate were prepared in different weight proportions and their viscosity was measured.

Table 2 shows the viscosity behavior of mixtures of rapeseed oil with different amorphous silicas or quartz sand and/or precipitated calcium carbonate in a weight ratio of 11:1.

TABLE 2

| | Dynamic viscosity [mPas] | |
|---|---|---|
| | Shear rate 1 s⁻¹ | Shear rate 300 s⁻¹ |
| Rapeseed oil + CaCO₃ (precipitated) | 346 | 104 |
| 11:1 (comparative) | | |
| Rapeseed oil + quartz sand 11:1 | 88 | 81 |
| (comparative) | | |
| Rapeseed oil + Sipernat 50 11:1 | 6454 | 248 |
| Rapeseed oil + Sipernat 22 S 11:1 | 23 768 | 307 |
| Rapeseed oil + Aerosil 200 F 11:1 | 9325 | 393 |
| Rapeseed oil + Sipernat D 17 11:1 | 448 | 123 |

As is seen, the mixtures according to the invention are thickened, but have a shear-thinning behavior, as can be perceived from the significantly lower viscosity at a shear rate of 300 s⁻¹ (by comparison with the viscosity at a shear rate of 1 s⁻¹).

Table 3 shows the viscosity behavior of mixtures of various oils with Sipernat® 22 S in a weight ratio of 11:1.

TABLE 3

| | Dynamic viscosity [mPas] | |
|---|---|---|
| | Shear rate 1 s⁻¹ | Shear rate 300 s⁻¹ |
| Rapeseed oil + Sipernat 22 S 11:1 | 23 768 | 307 |
| Sunflower oil + Sipernat 22 S 11:1 | 22 265 | 283 |
| Soybean oil + Sipernat 22 S 11:1 | 23 159 | 297 |
| RBD palm olein + Sipernat 22 S 11:1 | 13 999 | 221 |

Table 4 shows the viscosity behavior of mixtures of various oils with Aerosil® 200 F in a weight ratio of 22:1.

TABLE 4

| | Dynamic viscosity [mPas] | |
|---|---|---|
| | Shear rate 1 s⁻¹ | Shear rate 300 s⁻¹ |
| Rapeseed oil + Aerosil 200 F 22:1 | 1666 | 166 |
| Sunflower oil + Aerosil 200 F 22:1 | 1417 | 151 |
| Soybean oil + Aerosil 200 F 22:1 | 31 449 | 275 |
| RBD palm olein + Aerosil 200 F 22:1 | 15 029 | 483 |

Table 5 shows the viscosity behavior of mixtures of rapeseed oil with Sipernat® 22 S in various weight ratios.

TABLE 5

| | Dynamic viscosity [mPas] | |
|---|---|---|
| | Shear rate 1 s⁻¹ | Shear rate 300 s⁻¹ |
| Rapeseed oil + Sipernat 22 S 110:1 | 89 | 80 |
| (comparative) | | |
| Rapeseed oil + Sipernat 22 S 37:1 | 300 | 98 |
| Rapeseed oil + Sipernat 22 S 22:1 | 1990 | 133 |
| Rapeseed oil + Sipernat 22 S 11:1 | 23 768 | 307 |
| Rapeseed oil + Sipernat 22 S 11:2 | 163 440 | 637 |
| Rapeseed oil + Sipernat 22 S 11:3 | 304 500 | n.d. |

As can be perceived, for a weight ratio of 110:1 the thickening effect of Sipernat® 22 S is negligible.

Table 6 shows the viscosity behavior of mixtures of rapeseed oil with Aerosil® 200 F in various weight ratios.

TABLE 6

| | Dynamic viscosity [mPas] | |
|---|---|---|
| | Shear rate 1 s⁻¹ | Shear rate 300 s⁻¹ |
| Rapeseed oil + Aerosil 200 F 110:1 | 137 | 85 |
| (comparative) | | |
| Rapeseed oil + Aerosil 200 F 37:1 | 559 | 118 |
| Rapeseed oil + Aerosil 200 F 22:1 | 1666 | 166 |

As can be perceived, for a weight ratio of 110:1 the thickening effect of Aerosil® 200 F is not very pronounced.

Table 7 shows the temperature dependence of the viscosity of mixtures of rapeseed oil with Sipernat® 22 S in a weight ratio of 11:1.

TABLE 7
Dynamic viscosity [mPas]

| | Temp. | Shear rate 1 s⁻¹ | Shear rate 300 s⁻¹ |
|---|---|---|---|
| Rapeseed oil + Sipernat 22 | 20° C. | 23 327 | 303 |
| S 11:1 | 40° C. | 19 408 | 201 |
| | 60° C. | 12 088 | 143 |

Table 8 shows the temperature dependence of the viscosity of mixtures of rapeseed oil with Aerosil® 200 F in a weight ratio of 11:1.

TABLE 8
Dynamic viscosity [mPas]

| | Temp. | Shear rate 1 s⁻¹ | Shear rate 300 s⁻¹ |
|---|---|---|---|
| Rapeseed oil + Aerosil 200 | 20° C. | 9325 | 390 |
| F 11:1 | 40° C. | 6359 | 211 |
| | 60° C. | 4014 | 127 |

### 2) Treatment of Granules

Unless otherwise described, the granules were first charged with oil and homogenized for 15 seconds. Subsequently component B was added and homogenization took place for a further 45 seconds. The temperature which the granules each had during the treatment (between 25 and 60° C.) is reported below.

### 3) Study of the Dust Behavior

After one and after three weeks of storage, 100 g samples of granules were first stressed (about 40 rpm) by shaking using an overhead shaker (comparable with the RA 20 product from Gerhard) for 5 minutes in a flask (30 cm height; diameter 8 cm).

The dust count was then determined using a DustView II from PALAS. Here, after a 50 cm drop, a measurement is made of the attenuation of a laser beam after 0.5 and 30 s. This is done by applying a sample to a sample hopper. The opening of a flap allows the sample to fall into a dust chamber, where dust is swirled and attenuates the laser beam. The attenuation is expressed as a dust value, with a value of 0 denoting that the laser beam is not shadowed (i.e., only marginal dust fractions or none) and a value of 100 representing complete shadowing of the laser beam as a result of swirling dust. The dust count corresponds to the sum total of the dust value after 0.5 s and the dust value after 30 s following impact. The aim is for a dust count of less than 0.5, better still less than 0.3 or even less than 0.2.

The dust counts reported below correspond to the mean value from 4 measurements on 4 samples.

### 3.1) SOP Granules (Broken Granules)

The temperature of the base granules (=untreated SOP granules) on granule treatment (see 2)) was 40° C.

Table 9 shows the dust behavior of granules obtained by treating broken SOP granules with rapeseed oil and various silicas in a weight ratio of 11:1, after 1-week and 3-week storage. The quantities of oil and silica used per metric ton of base granules are reported. For comparison, studies were carried out on the base granules in untreated form, in a form treated only with rapeseed oil, or in a form treated with a mixture of rapeseed oil and quartz sand or calcium carbonate.

TABLE 9
SOP

| | Dust count | Dust count |
|---|---|---|
| Treatment | 1-week value | 3-week value |
| untreated | 22.2 | 26.8 |
| +5.5 kg/t Rapeseed oil | 1.0 | 1.1 |
| +5.5 kg/t Rapeseed oil | 0.1 | 0.1 |
| +0.5 kg/t Sipernat 22 S | | |
| +5.5 kg/t Rapeseed oil | 0.1 | 0.1 |
| +0.5 kg/t Aerosil 200 F | | |
| +5.5 kg/t Rapeseed oil | 0.0 | 0.0 |
| +0.5 kg/t Sipernat 50 | | |
| +5.5 kg/t Rapeseed oil | 0.2 | 0.2 |
| +0.5 kg/t Sipernat D 17 | | |
| +5.5 kg/t Rapeseed oil | 0.9 | 1.1 |
| +0.5 kg/t Quartz sand | | |
| +5.5 kg/t Rapeseed oil | 0.7 | 0.8 |
| +0.5 kg/t Precipitated CaCO₃ | | |

As can be seen, the treatment in the invention leads to the most effective suppression of dust evolution. The use solely of amorphous silicas, such as Sipernat 22 S, Sipernat 50, Sipernat D 17 or Aerosil 200 F, for example, does not lead to a reduction in the dust count.

Table 10 shows the dust behavior of granules obtained by treating broken SOP granules with various oils and Sipernat® 22 S or Aerosil® 200 F in a weight ratio of 11:1, after 1-week and 3-week storage. The quantities of oil and silica used per metric ton of base granules are reported. For comparison, studies were carried out on the base granules in untreated form and in a form treated only with the respective oil.

TABLE 10
SOP

| | Dust count | Dust count |
|---|---|---|
| Treatment | 1-week value | 3-week value |
| untreated | 22.2 | 26.8 |
| +5.5 kg/t Rapeseed oil | 1.0 | 1.1 |
| +5.5 kg/t Rapeseed oil | 0.1 | 0.1 |
| +0.5 kg/t Sipernat 22 S | | |
| +5.5 kg/t Rapeseed oil | 0.1 | 0.1 |
| +0.5 kg/t Aerosil 200 F | | |
| +5.5 kg/t Sunflower oil | 2.2 | 1.5 |
| +5.5 kg/t Sunflower oil | 0.1 | 0.0 |
| +0.5 kg/t Sipernat 22 S | | |
| +5.5 kg/t Sunflower oil | 0.1 | 0.1 |
| +0.5 kg/t Aerosil 200 F | | |
| +5.5 kg/t Soybean oil | 1.2 | 1.0 |
| +5.5 kg/t Soybean oil | 0.1 | 0.1 |
| +0.5 kg/t Sipernat 22 S | | |
| +5.5 kg/t Soybean oil | 0.1 | 0.1 |
| +0.5 kg/t Aerosil 200 F | | |
| +5.5 kg/t RBD Palm Olein | 0.9 | 1.3 |
| +5.5 kg/t RBD Palm Olein | 0.1 | 0.2 |
| +0.5 kg/t Sipernat 22 S | | |
| +5.5 kg/t RBD Palm Olein | 0.1 | 0.2 |
| +0.5 kg/t Aerosil 200 F | | |

All combinations according to the invention exhibit outstandingly low dust count values. The use solely of amorphous silicas, such as Sipernat 22 S or Aerosil 200 F, for example, does not lead to a reduction in the dust count.

Table 11 shows the dust behavior of granules obtained by treatment of broken SOP granules by various methods (mixing methods) with rapeseed oil and Sipernat® 22 S in a weight ratio of 11:1, after 1-week and 3-week storage. The quantities of oil and silica used per metric ton of base granules are reported. For comparison, studies were carried out on the base granules in untreated form and in a form treated only with rapeseed oil.

TABLE 11
SOP

| | Dust count | Dust count |
|---|---|---|
| Treatment | 1-week value | 3-week value |
| untreated | 22.2 | 26.8 |
| +5.5 kg/t Rapeseed oil | 1.0 | 1.1 |
| +5.5 kg/t Rapeseed oil | 0.1 | 0.1 |
| +0.5 kg/t Sipernat 22 S | | |
| +5.5 kg/t Rapeseed oil | 0.1 | 0.1 |
| +0.5 kg/t Sipernat 22 S | | |
| mixed manually via glass rod for 1 min prior | | |
| to addition | | |
| +5.5 kg/t Rapeseed oil | 0.1 | 0.1 |
| +0.5 kg/t Sipernat 22 S | | |
| mixed via paddle stirrer for 1 min prior to | | |
| addition (300 rpm) | | |
| +5.5 kg/t Rapeseed oil | 0.1 | 0.1 |
| +0.5 kg/t Sipernat 22 S | | |
| mixed via Ultra-Turrax for 1 min prior to | | |
| addition (20 000 rpm) | | |

As can be seen, the different mixing methods have no consequence for the dust-binding effect.

Table 12 shows the dust behavior of granules obtained by treating broken SOP granules with rapeseed oil/palm oil mixtures and with various Sipernat® silicas in a weight ratio of 11:1, after 1-week, 3-week and 6-week storage. The quantities of oil and silica used per metric ton of base granules are reported. For comparison the base granules were studied in untreated form.

TABLE 12
SOP

| | Dust count | Dust count | Dust count |
|---|---|---|---|
| Treatment | 1-week value | 3-week value | 6-week value |
| untreated | 22.2 | 26.8 | 20.0 |
| +5.5 kg/t Rapeseed oil | 0.1 | 0.1 | 0.0 |
| +0.5 kg/t Sipernat 22 S | | | |
| +5.5 kg/t Rapeseed oil/palm | 0.1 | 0.0 | 0.0 |
| oil 50:50 | | | |
| +0.5 kg/t Sipernat 22 S | | | |
| +5.5 kg/t Rapeseed oil/palm | 0.1 | 0.1 | 0.0 |
| oil 50:50 | | | |
| +0.5 kg/t Sipernat 50 | | | |
| +5.5 kg/t Rapeseed oil/palm | 0.3 | 0.2 | 0.3 |
| oil 50:50 | | | |
| +0.5 kg/t Sipernat D 17 | | | |

Table 13 shows the dust behavior of granules obtained by treating broken SOP granules with rapeseed oil and with Sipernat® 22 S in various weight ratios, after 1-week and 3-week storage. The quantities of oil and silica used per metric ton of base granules are reported. For comparison, studies were carried out on the base granules in untreated form and in a form treated only with rapeseed oil.

TABLE 13
SOP

| | Dust count | Dust count |
|---|---|---|
| Treatment | 1-week value | 3-week value |
| untreated | 22.2 | 26.8 |
| +5.5 kg/t Rapeseed oil | 1.0 | 1.1 |
| +5.5 kg/t Rapeseed oil | 1.1 | 0.9 |
| +0.05 kg/t Sipernat 22 S | | |
| +5.5 kg/t Rapeseed oil | 0.4 | 0.5 |
| +0.15 kg/t Sipernat 22 S | | |
| +5.5 kg/t Rapeseed oil | 0.4 | 0.2 |
| +0.25 kg/t Sipernat 22 S | | |
| +5.5 kg/t Rapeseed oil | 0.1 | 0.1 |
| +0.5 kg/t Sipernat 22 S | | |
| +5.5 kg/t Rapeseed oil | 0.0^{#} | 0.0^{#} |
| +1.0 kg/t Sipernat 22 S | | |
| +5.5 kg/t Rapeseed oil | 0.0^{#} | 0.0^{#} |
| +1.5 kg/t Sipernat 22 S | | |
| +5.5 kg/t Rapeseed oil | 0.0^{##} | 0.0^{##} |
| +2.5 kg/t Sipernat 22 S | | |

^{#}slight sticking observed on the vessel wall during shaking
^{##}granules stick severely and can no longer be handled

Table 14 shows the dust behavior of granules obtained by treating broken potassium sulfate (SOP) granules with rapeseed oil and with Aerosil® 200 F in various weight ratios, after 1-week and 3-week storage. The quantities of oil and silica used per metric ton of base granules are reported. For comparison, studies were carried out on the base granules in untreated form and in a form treated only with rapeseed oil.

TABLE 14
SOP

| | Dust count | Dust count |
|---|---|---|
| Treatment | 1-week value | 3-week value |
| untreated | 22.2 | 26.8 |
| +5.5 kg/t Rapeseed oil | 1.0 | 1.1 |
| +5.5 kg/t Rapeseed oil | 0.6 | 0.8 |
| +0.05 kg/t Aerosil 200 F | | |
| +5.5 kg/t Rapeseed oil | 0.4 | 0.3 |
| +0.15 kg/t Aerosil 200 F | | |
| +5.5 kg/t Rapeseed oil | 0.2 | 0.2 |
| +0.25 kg/t Aerosil 200 F | | |
| +5.5 kg/t Rapeseed oil | 0.1 | 0.1 |
| +0.5 kg/t Aerosil 200 F | | |
| +5.5 kg/t Rapeseed oil | 0.0^{#} | 0.0^{#} |
| +1.0 kg/t Aerosil 200 F | | |
| +5.5 kg/t Rapeseed oil | 0.0^{#} | 0.0^{#} |
| +1.5 kg/t Aerosil 200 F | | |
| +5.5 kg/t Rapeseed oil | 0.0^{##} | 0.0^{##} |
| +2.5 kg/t Aerosil 200 F | | |

^{#}slight sticking observed on the vessel wall during shaking
^{##}granules stick severely and can no longer be handled

Studies with conventional antidusting agents based on thickened mineral oils show that the combination according to the invention leads to a comparable dust-binding effect in fertilizer granules.

### 3.2) MOP Granules (Broken Granules)

The temperature of the base granules (=untreated MOP granules) on granule treatment was 60° C.

Table 15 shows the dust behavior of granules obtained by treating broken MOP granules with rapeseed oil and with Sipernat® 22 S or Aerosil® 200 F in a weight ratio of about 11:1, after 1-week and 3-week storage (15 min instead of 5 min of stressing for determining the value after 3-week storage). The quantities of oil and silica used per metric ton of base granules are reported. For comparison, studies were carried out on the base granules in untreated form and in a form treated only with rapeseed oil.

TABLE 15
MOP

| | Dust count | Dust count |
|---|---|---|
| Treatment | 1-week value | 3-week value |
| untreated | 2.8 | 10.4* |
| +2.5 kg/t Rapeseed oil | 0.0 | 0.2* |
| +2.5 kg/t Rapeseed oil | 0.0 | 0.0* |
| +0.23 kg/t Sipernat 22 S | | |
| +2.5 kg/t Rapeseed oil | 0.0 | 0.0* |
| +0.23 kg/t Aerosil 200 F | | |

*stressed for 15 min rather than 5 min.

### 3.3) Granules Based on Korn-Kali (Granular Potash) (Broken Granules)

The temperature of the base granules (=untreated Korn-Kali granules) on granule treatment (see 2)) was 50° C.

Table 16 shows the dust behavior of granules obtained by treating broken Korn-Kali granules with rapeseed oil and with Sipernat® 22 S or Aerosil® 200 F in a weight ratio of about 11:1, after 1-week and 3-week storage. The quantities of oil and silica used per metric ton of base granules are reported. For comparison, studies were carried out on the base granules in untreated form and in a form treated only with rapeseed oil.

TABLE 16
Korn-Kali

| | Dust count | Dust count |
|---|---|---|
| Treatment | 1-week value | 3-week value |
| untreated | 16.3 | 12.1 |
| +4.5 kg/t Rapeseed oil | 3.6 | 3.8 |
| +4.5 kg/t Rapeseed oil | 0.1 | 0.1 |
| +0.41 kg/t Sipernat 22 S | | |
| +4.5 kg/t Rapeseed oil | 0.0 | 0.0 |
| +0.41 kg/t Aerosil 200 F | | |

### 3.4) Patentkali (Patent Potash) Granules (Roll Granules)

The temperature of the base granules (=untreated Patentkali granules) on granule treatment was 25° C.

Table 17 shows the dust behavior of granules obtained by treating Patentkali roll granules with rapeseed oil and with Sipernat® 22 S in a weight ratio of 9:1, after 1-week and 3-week storage. The quantities of oil and silica used per metric ton of base granules are reported. For comparison, studies were carried out on the base granules in untreated form.

TABLE 17
Patentkali granules

| | Dust count | Dust count |
|---|---|---|
| Treatment | 1-week value | 3-week value |
| untreated | 19.3 | 20.1 |
| +2.7 kg/t Rapeseed oil | 0.2 | 0.2 |
| +0.3 kg/t Sipernat 22 S | | |

### 3.5) NPK Granules

The temperature of the base granules (=untreated NPK granules) on granule treatment was 20° C.

Table 18 shows the dust behavior of granules obtained by treating NPK granules with rapeseed oil and with Sipernat® 22 S or Aerosil® 200 F in a weight ratio of 10:1, after 1-week and 3-week storage. The quantities of oil and silica used per metric ton of base granules are reported. For comparison, studies were carried out on the base granules in untreated form and in a form treated only with rapeseed oil.

TABLE 18
NPK granules

| | Dust count | Dust count |
|---|---|---|
| Treatment | 1-week value | 3-week value |
| untreated | 16.4 | 19.7 |
| +3.0 kg/t Rapeseed oil | 0.6 | 0.8 |
| +3.0 kg/t Rapeseed oil | 0.1 | 0.1 |
| +0.3 kg/t Sipernat 22 S | | |
| +3.0 kg/t Rapeseed oil | 0.1 | 0.1 |
| +0.3 kg/t Aerosil 200 F | | |

### 3.6) SOP Granules (Broken Granules)—Various Treatment Methods

The temperature of the base granules (=untreated SOP granules) on granule treatment was 20° C.

Table 19 shows the dust behavior of granules obtained by various treatment methods (joint or separate addition of silica and oil) for broken SOP granules with RBD palm olein and Sipernat® 22 S in a weight ratio of 11:1, after 1-week and 3-week storage. The quantities of oil and silica used per metric ton of base granules are reported.

TABLE 19
SOP

| | Dust count | Dust count |
|---|---|---|
| Treatment | 1-week value | 3-week value |
| +5.5 kg/t RBD Palm olein | 0.1 | 0.1 |
| +0.5 kg/t Sipernat 22 S | | |
| separate but concurrent addition | | |
| +5.5 kg/t RBD Palm olein | 0.2 | 0.1 |
| +0.5 kg/t Sipernat 22 S | | |
| first addition of RBD Palm olein; | | |
| addition of Sipernat 22 S after 15 s | | |
| +5.5 kg/t RBD Palm olein | 0.1 | 0.1 |
| +0.5 kg/t Sipernat 22 S | | |
| first addition of Sipernat 22 S; | | |
| addition of RBD Palm olein after 15 s | | |

1. A process for reducing the dust evolution of granules based on inorganic salts or urea, more particularly of fertilizer granules, which comprises treating the granules with a quantity of a combination comprising:
c) at least one fatty acid triglyceride liquid at 20° C. or at least one fatty acid triglyceride mixture liquid at 20° C., as component A;
d) at least one amorphous hydrophilic silica as component B,
where said quantity reduces the dusting of the granules and where the mass ratio of component A to component B in said combination is in the range from 40:1 to 3:1.

2. The process as claimed in claim 1, where component A is selected from vegetable oils, more particularly vegetable oils having a Wijs iodine value in the range from 20 to 160, determined according to DIN 53241-1:1995-05, and mixtures of vegetable oils, with at least one of the vegetable oils contained in the mixture having this iodine number.

3. The process as claimed in claim 1 or 2, where component A has a dynamic viscosity as determined according to DIN 53019-1:2008-09, in the range from 20 to 200 mPas at 20° C. and a shear rate of 1 s⁻¹.

4. The process as claimed in any of the preceding claims, where component A is selected from rapeseed oil, sunflower oil, corn oil, soybean oil, cottonseed oil, peanut oil, olive oil, safflower oil, hemp oil, palm olein, and mixtures thereof, and also mixtures of at least one of the aforesaid vegetable oils with palm oil or coconut oil; and where component A more particularly is selected from rapeseed oil, sunflower oil, soybean oil, palm olein, mixtures thereof, and also mixtures of at least one of the aforesaid vegetable oils with palm oil.

5. The process as claimed in any of the preceding claims, where component B has a specific surface area as determined by nitrogen adsorption according to the BET method to DIN ISO 9277:2014-01 at 77.3 K of at least 50 m²/g, more particularly in the range from 80 to 600 m²/g.

6. The process as claimed in any of the preceding claims, where component B is selected from fumed silica, precipitated silica, and mixtures thereof.

7. The process as claimed in any of the preceding claims, where the combination consists to an extent of at least 80 wt %, preferably at least 85 wt %, more particularly at least 90 wt %, especially at least 95 wt %, based on the total weight of the combination, of components A and B.

8. The process as claimed in any of the preceding claims, where the granules are selected from granules based on sulfate, chloride, phosphate or nitrate salts of potassium, magnesium, calcium or ammonium, based on mixtures thereof, based on mixed salts thereof, based on mixtures of mixed salts thereof with at least one of the above-stated salts, based on urea, or based on a mixture of at least one of the above-stated salts or mixed salts with urea; where the granules more particularly are selected from MOP, SOP, Korn-Kali (granular potash), Patentkali (patent potash), kieserite, ammonium sulfate, MAP, DAP, CAS, TSP, NPK, polyhalite, and urea granules, and also granules containing at least two of these components.

9. The process as claimed in any of the preceding claims, where components A and B are used separately or in a mixture for treating the granules, the granules in the case of separate use being treated concurrently with component A and component B.

10. The process as claimed in claim 9, where the combination of components A and B is used in the form of an oil composition which contains
a) 75 to 97.6 wt %, preferably 83.3 to 97.6 wt %, more preferably 87.5 to 96.8 wt %, more particularly 88.9 to 96.4 wt %, especially 88.9 to 96.2 wt %, based on the total weight of the oil composition, of component A; and
b) 2.4 to 25 wt %, preferably 2.4 to 16.7 wt %, more preferably 3.2 to 12.5 wt %, more particularly 3.6 to 11.1 wt %, especially 3.8 to 11.1 wt %, based on the total weight of the oil composition, of component B.

11. The process as claimed in claim 10, where the oil composition is shear-thinning.

12. The process as claimed in claim 11, where the oil composition at 20° C. and a shear rate of 1 s⁻¹ has a dynamic viscosity of at least 500 mPas and at 20° C. and a shear rate of 300 s⁻¹ has a dynamic viscosity which is at least 200 mPas below the dynamic viscosity of the oil composition at 20° C. and a shear rate of 1 s⁻¹) the viscosity values being determined according to DIN 53019-1:2008-09.

13. The process as claimed in any of claims 1 to 8, where components A and B are used separately and successively for treating the granules, the time interval between the treatment with component A and the treatment with component B being at most 2 minutes, preferably at most 1 minute, more particularly at most 30 seconds.

14. The process as claimed in any of the preceding claims, where the combination contains component A and component B in a mass ratio A:B in the range from 40:1 to 5:1, preferably in the range from 30:1 to 7:1, more particularly in the range from 27:1 to 8:1, and especially in the range from 25:1 to 9:1.

15. The process as claimed in any of the preceding claims, where the combination is used in an amount of 1 to 10 kg per metric ton of granules, more particularly of 2 to 7 kg per metric ton of granules.

16. The use of a combination comprising
c) at least one fatty acid triglyceride liquid at 20° C. or at least one fatty acid triglyceride mixture liquid at 20° C., as component A;
d) at least one amorphous silica as component B,
where the mass ratio of component A to component B in said combination is in the range from 40:1 to 3:1, as an antidusting agent for granules based on inorganic salts or for urea granules, more particularly for fertilizer granules.

17. The use as claimed in claim 16, where the combination has at least one of the features of claims 1 to 14.

18. An oil composition containing
c) 75 to 97.6 wt %, based on the total weight of the oil composition, of a fatty acid triglyceride liquid at 20° C. or of at least one fatty acid triglyceride mixture liquid at 20° C., as component A, where component A has a dynamic viscosity as determined according to DIN 53019-1:2008-09 in the range from 20 to 200 mPas at 20° C. and a shear rate of 1 s⁻¹;
d) 2.4 to 25 wt %, based on the total weight of the oil composition, of at least one amorphous hydrophilic silica as component B,
where component B is present in the oil composition in an amount of at least 6.5 wt %, based on the total weight of the oil composition, when component B is fumed silica.

19. The oil composition as claimed in claim 18, where component A has at least one of the features of claim 2 or 4.

20. The oil composition as claimed in either of claims 18 and 19, where component B has at least one of the features of claim 5 or 6.

21. The oil composition as claimed in any of claims 18 to 20, containing
c) 83.3 to 97.6 wt %, preferably 87.5 to 96.8 wt %, more particularly 88.9 to 96.4 wt %, especially 88.9 to 96.2 wt %, based on the total weight of the oil composition, of component A; and
d) 2.4 to 16.7 wt %, preferably 3.2 to 12.5 wt %, more particularly 3.6 to 11.1 wt %, especially 3.8 to 11.1 wt %, based on the total weight of the oil composition, of component B.

22. The oil composition as claimed in any of claims 18 to 21, containing component A and component B in a mass ratio A:B in the range from 40:1 to 3:1, preferably in the range from 40:1 to 5:1, more preferably in the range from 30:1 to 7:1, more particularly in the range from 27:1 to 8:1, and especially in the range from 25:1 to 9:1.

23. The oil composition as claimed in any of claims 18 to 22, where the oil composition is shear-thinning.

24. Granules obtainable by the process as claimed in any of claims 1 to 15.
